(19) United States
(12) Patent Application Publication
(10) Pub. No.: US 2006/0278280 A1
(43) Pub. Date: Dec. 14, 2006

(54) Check valve

(76) Inventor: Tzai-Jen Yang, Chung Hua Hsien (TW)

Correspondence Address: Tzai-Jen Yang;235 Chung - Ho, Box 8-24, Chung Hua Hsien, TW

(21) Appl. No.: 11/134,672

(22) Filed: May 23, 2005

(51) Int. Cl. F16K 15/06

(52) U.S. Cl. 137/542

(57) ABSTRACT

A check valve has a sleeve threaded to a seat so that an adjusting rod, a valve rod and a spring can be installed therein. The sleeve has a water inlet and a plurality of through holes so that when water flows into the valve body from the water inlet of the sleeve, the pressure of the water flow will press the valve rod to move upwards. Then water will flow out from the through hole of the sleeve. When the valve rod moves downwards, the pressures of the water flow and the spring will seal the water inlet to prevent the water flows reversely. Furthermore, the valve body has an integral structure. No part will lose in maintenance. Moreover the assembly speed will be increased.

### FIELD OF THE INVENTION

The present invention relates to check valves, and in particular to a check valve, wherein a sleeve is threaded to a seat. An adjusting rod, a spring, and a valve rod are used so that in maintenance, the whole check valve can be taken out wholly to improve the defects of easily losing elements and difficulty in taking out the check valve in the prior art. Thereby the check valve can be assembled quickly to be massively produced.

### BACKGROUND OF THE INVENTION

One prior art check valve is formed by a valve body, a cover, a valve rod, and a spring. The valve rod is configured corresponding to a via hole. The valve rod is slidably installed in a receiving groove of the cover. The spring is installed between the valve rod and the cover. The valve rod moves as a plug. When the valve rod moves upwards, the water flows. When the valve rod moves downwards, the via hole is closed to have the effect of preventing the water from flowing reversely. The structure can be assembled easily and has a preferred water sealing effect. However in use of the structure, if the valve body is too long, it is difficult to take the valve rod and the spring as the cove is taken out. Furthermore, it is possible that the spring or other parts are left in the valve body, even some parts will lose.

### SUMMARY OF THE INVENTION

Accordingly, the primary object of the present invention is to provide a check valve, wherein a sleeve is threaded to a seat. An adjusting rod, a spring, and a valve rod are used so that in maintenance, the whole check valve can be taken out wholly to improve the defects of easily losing elements and difficulty in taking out the check valve in the prior art. Thereby the check valve can be assembled quickly to be massively produced.

To achieve above object, the present invention provides a check valve is installed to a valve body. The valve body has an adjusting opening; a spacer being installed within the valve body. The spacer spaces the receiving space of the valve body into two parts. The spacer has a via hole. The check valve includes a seat having a penetrating hole; the seat having a first end, a second end and a third end; a periphery of the first end being formed with a polygonal surface for engaging with a tool; peripheries of the second end and the third end being formed with threaded portions, respectively, the threaded portion of the second end being screwable to an adjusting opening of the valve body; and the threaded portion of the third end; an adjusting rod serving for adjusting water flowing through the check valve; the adjusting rod being installed within the penetrating hole of the seat and having a receiving groove corresponding to the via hole of the spacer; a valve rod having a rod body; the valve rod being slidably installed within the receiving groove of the adjusting rod; one end of the valve rod having a plug and the plug having an annular groove for receiving a sealing block; a spring being installed between the valve rod and the adjusting rod; one end of the spring being in contact with the valve rod and another end thereof being in contact with the adjusting rod; a sleeve having an opening at one end thereof and screwable to the threaded portion of the third end; and another end of the sleeve having a water inlet corresponding to a via hole of the spacer; a periphery of the sleeve having a plurality of through holes so that water can flow out from the through hole.

The various objects and advantages of the present invention will be more readily understood from the following detailed descriptions of three preferred embodiments when read in conjunction with the respective appended drawings.

### BRIEF DESCRIPTION OF THE DRAWINGS

FIG. 1 is an exploded perspective view of the check valve of the present invention.

FIG. 2 is a cross sectional view about the check valve of the present invention.

FIG. 3 is a cross sectional view about the valve body of the check valve of the present invention.

FIG. 4 is a perspective view about the assembly of the valve body of the check valve of the present invention.

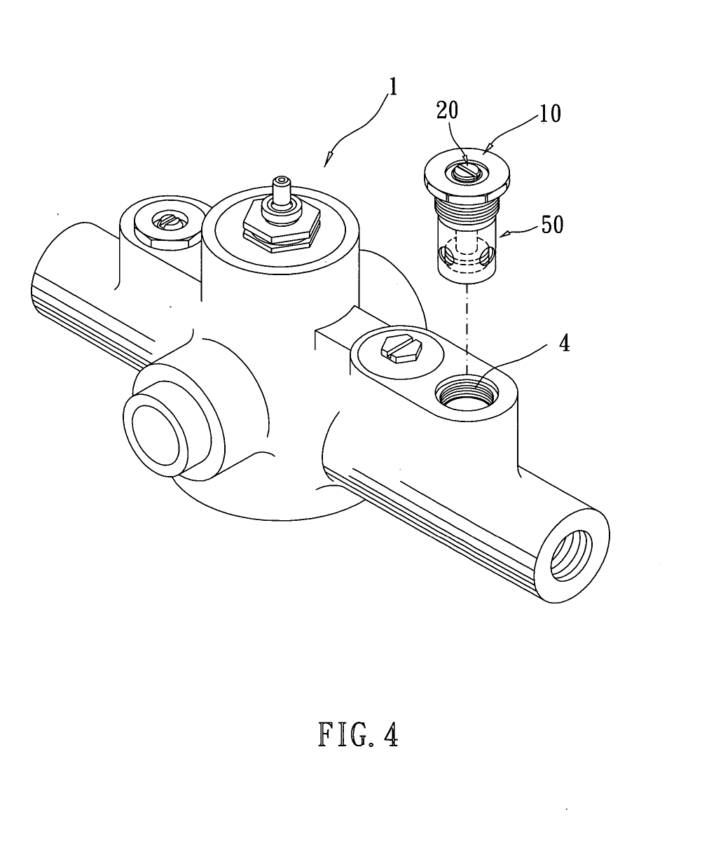

### DETAILED DESCRIPTION OF THE PREFERRED EMBODIMENTS

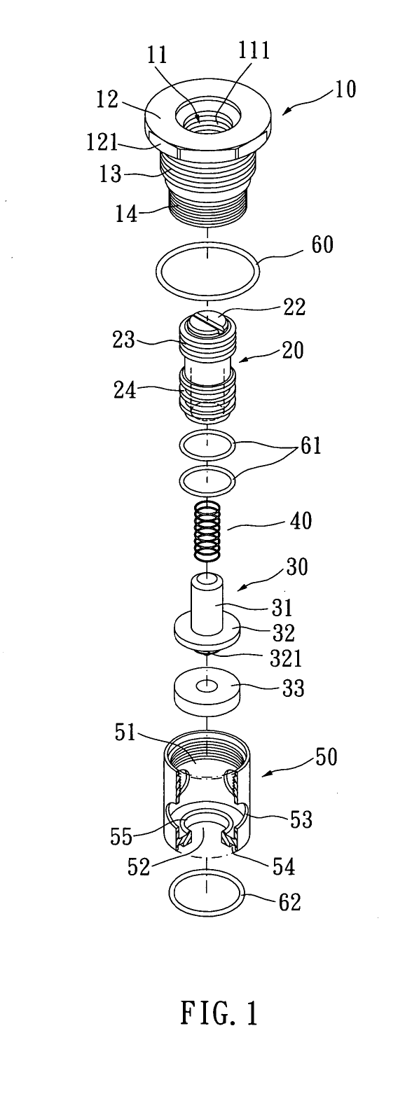

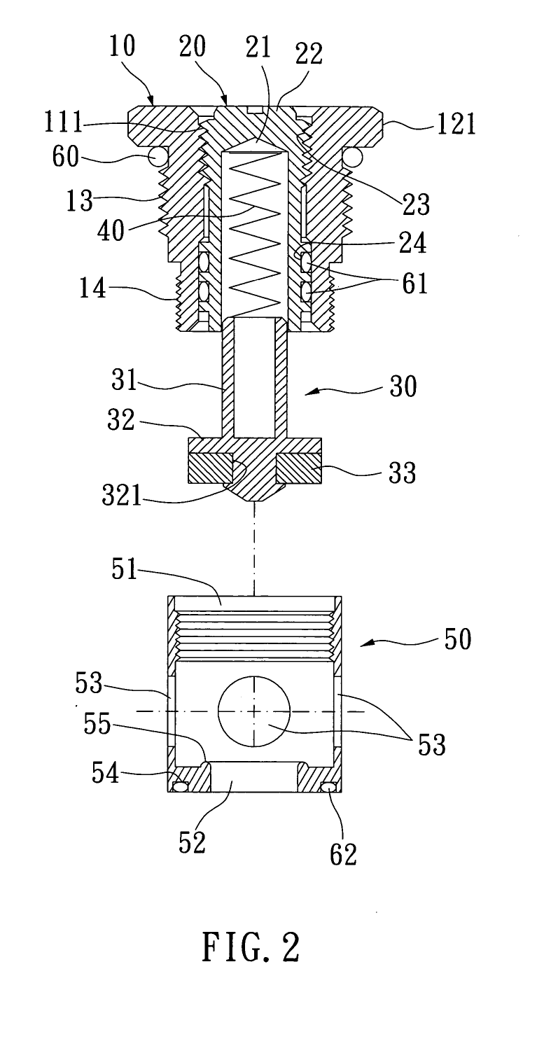

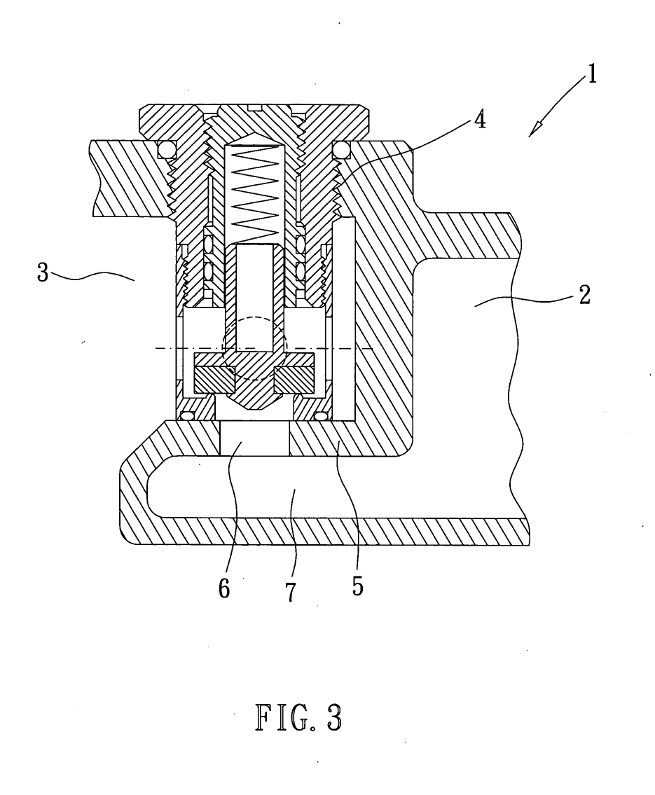

Referring to FIGS. 1 to 3, the check valve of the present invention is installed in a valve body 1. The valve body 1 has a water inlet 2, a water outlet 3 and an adjusting opening 4. A spacer 5 is installed within the valve body 1. The spacer 5 spaces the receiving space 7 of the valve body 1 into two parts. The spacer 5 has a via hole 6. Thereby water can flow through the valve body 1. The check valve of the present invention is installed within the adjusting opening 4.

The check valve of the present invention includes a seat 10, an adjusting rod 20, a valve rod 30, a spring 40 and a sleeve 50.

The seat 10 has a penetrating hole 11. The penetrating hole 11 has inner threads 111. The outer side of the seat 10 has a first end 12, a second end 13 and a third end 14. An outer side of the first end 12 is formed as a polygonal surface 121 for receiving a spanner to drive the check valve. Peripheries of the second end 13 and third end 14 are installed with threaded portions. The threaded portion of the second end 13 is screwed into an adjusting opening 4. The threaded portion of the third end 14 serves to be engaged to an opening 51 of the sleeve 50.

The adjusting rod 20 serves for adjusting the water flow and is installed within the penetrating hole 11 of the seat 10. A top of the adjusting rod 20 has an adjusting end 22. A repair tool can adjust the present invention through the adjusting end 22. A bottom of the adjusting rod 20 has a receiving groove 21 corresponding to the via hole 6 of the spacer 5. The receiving groove 21 provides a sliding space to the rod body 31 of a valve rod 30. An outer side of the adjusting rod 20 is formed with an annular groove 24 for being enclosed by at least one washer 61 (in the drawing, there are two washers 61 are illustrated) to seal water.

The valve rod 30 is formed by a rod body 31, a plug 32 and a sealing block 33. The rod body 31 is at one end of the valve rod 30. The rod body 31 is slidably assembled in the receiving groove 21 of the adjusting rod 20. Another end of the valve rod 30 has a plug 32. A front end of the plug has an annular recess 321 which receives a soft sealing block 33 form of rubber. The soft sealing block 33 has a preferred sealing effect.

The spring 40 is installed between the valve rod 30 and the adjusting rod 20. One end of the spring 40 is in contact with the valve rod 30 and another end thereof is in contact with the adjusting rod 20. By the resilient force of the spring 40, the valve rod 30 is slidable so as to have the effect of water sealing in one direction.

The sleeve 50 has an opening 51 at a top end thereof and is screwable to the threaded portion of the third end 14 of the seat 10. A bottom end of the sleeve 50 is corresponding to the water inlet 52 of the via hole 6 of the spacer 5. A periphery of the sleeve 50 is annularly formed with a plurality of through holes 53. Water can flow out from the through holes 53. Water enters into the water outlet 2 of the valve body 1 and then passes through the via hole 6 of the spacer 5 and then into the water inlet 52 of the sleeve 50 so that water can be sealed effectively. The water inlet 52 of the sleeve 50 is arranged corresponding to one end of the valve rod 30. A ring portion 55 is protruded annularly around the water inlet 52 for adhering tightly with the sealing block 33 of the valve rod 30. When water enters into the water inlet 52 of the sleeve 50, the water pressure will resist against the valve rod 30. The water pressure is greater than the elastic force of the spring so that the valve rod 30 moves upwards. Then water will flow out from the through holes 53 of the sleeve. When water flows along a reverse direction, the water pressure and the spring elastic force will push the valve rod 30 to move downwards to close the water inlet 52 of the sleeve 50 to seal the water.

In use of the check valve of the present invention, the seat 10 is screwed to the sleeve 50. The adjusting rod 20, spring 40 and the valve rod 30 are installed therein. Thereby the parts will not be left in the valve body 1 in repair or assembly. Thereby the defect that it is difficult to taking out the valve rod and spring as the adjusting opening is too deep is improved. In assembly of the check valve of the present invention, the check valve can be assembled at first integrally and then it is assembled to the adjusting opening of the valve body so as to reduce the assembled time of the check valve and the assembly process of the check valve is simplified. The times of making mistakes are reduced.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A check valve installed to a valve body; the valve body having an adjusting opening; a spacer being installed within the valve body; the spacer spacing the receiving space of the valve body into two parts; the spacer having a via hole; comprising:
a seat having a penetrating hole; the seat having a first end, a second end and a third end; a periphery of the first end being formed with a polygonal surface for engaging with a tool; peripheries of the second end and the third end being formed with threaded portions, respectively, the threaded portion of the second end being screwable into the adjusting opening of the valve body; and the threaded portion of the third end;
an adjusting rod serving for adjusting water flowing through the check valve; the adjusting rod being installed within the penetrating hole of the seat and having a receiving groove corresponding to the via hole of the spacer;
a valve rod having a rod body; the valve rod being slidably installed within the receiving groove of the adjusting rod; one end of the valve rod having a plug and the plug having an annular groove for receiving a sealing block;
a spring being installed between the valve rod and the adjusting rod; one end of the spring being in contact with the valve rod and another end thereof being in contact with the adjusting rod;
a sleeve having an opening at one end thereof and screwable to the threaded portion of the third end; and another end of the sleeve having a water inlet corresponding to a via hole of the spacer; a periphery of the sleeve having a plurality of through holes so that water can flow out from the through hole.

2. The check valve as claimed in claim 1, wherein to prevent water from flowing out from between the adjusting rod and the seat; a lateral side of the adjusting rod is formed with annular groove for installing a washer.

3. The check valve as claimed in claim 1, wherein a top of the adjusting rod has an adjusting end for adjusting water flow.

4. The check valve as claimed in claim 1, wherein an interior of the penetrating hole of the seat is installed with inner threads; and outer periphery of the adjusting rod are installed with outer threads so that the adjusting rod is rotatable for controlling water flow.

5. The check valve as claimed in claim 1, wherein one end of the water inlet of the sleeve corresponding to the via hole of the spacer is annularly installed with a groove for receiving an washer.

6. The check valve as claimed in claim 1, wherein a ring portion is protruded annularly around the water inlet for adhering tightly with the sealing block of the valve rod.
